(19) United States
(12) Patent Application Publication
(10) Pub. No.: US 2026/0361635 A1
(43) Pub. Date: Nov. 12, 2026

(54) SYSTEMS AND METHODS FOR IMPROVED MONITORING OF A NETWORK TOPOLOGY AND CORRESPONDING USER INTERFACES

(71) Applicant: Aviatrix Systems, Inc., Santa Clara, CA (US)

(72) Inventors: Brighton Vino Jegarajan, Santa Clara, CA (US); Arno Lenin Malyala, Santa Clara, CA (US); Joshua Wu, Santa Clara, CA (US); Shiva Sundarrajan, Santa Clara, CA (US); Henry Luo, Santa Clara, CA (US); Michael Hu, Santa Clara, CA (US); Josh Cridlebaugh, Santa Clara, CA (US); Ken Crimmins, Santa Clara, CA (US); Praveen Raju Kariyanahalli, Santa Clara, CA (US); Khanh Nguyen, Santa Clara, CA (US)

(73) Assignee: Aviatrix Systems, Inc., Santa Clara, CA (US)

(21) Appl. No.: 19/118,684

(22) PCT Filed: Oct. 4, 2023
(86) PCT No.: PCT/US2023/034494

§ 371 Date: Apr. 4, 2025

Related U.S. Application Data
(60) Provisional application No. 63/412,880, filed on Oct. 4, 2022.

(51) Int. Cl. H04L 43/20; H04L 41/122; H04L 41/22; H04L 43/0876; H04L 67/75

(52) U.S. Cl. CPC H04L 43/20; H04L 41/122; H04L 41/22; H04L 43/0876; H04L 67/75

(57) ABSTRACT

A distributed cloud computing system is disclosed that includes a. controller configured to deploy a first gateway in a first cloud computing network and a second gateway in a second cloud computing network. The system includes logic stored on non-transitory, computer-medium, that, upon execution by one or more processors, causes performance of operations including: receiving, from a controller, metadata pertaining to a plurality of constructs; receiving, from each of the first gateway and the second gateway, network data, wherein a combination of the metadata and the network data identify each of the plurality' of constructs and in which cloud computing network each construct is deployed: generating a visualization illustrating a cost analysis of at least one construct of the plurality of constructs, and causing rendering of the visualization on a display' screen of a network device.

### CROSS-REFERENCE TO RELATED APPLICATIONS

This application claims the benefit of priority on U.S. Provisional Patent Application No. 63/412,880 filed Oct. 4, 2022, the entire contents of which is incorporated by reference herein.

### TECHNICAL FIELD

Embodiments of the disclosure relate to the field of cloud networking. More specifically, one embodiment of the disclosure is directed to a system and method for providing operational visibility of an enterprise network spanning a single public cloud network or a multiple public cloud networks.

### GENERAL BACKGROUND

Until recently, businesses have relied on application software installed on one or more electronic devices residing in close proximity to its user (hereinafter, “on-premises electronic devices”). These on-premises electronic devices may correspond to an endpoint device (e.g., personal computer, cellular smartphone, netbook, etc.), a locally maintained mainframe, or even a local server for example. Depending on the size of the business, the purchase of the on-premises electronic devices and their corresponding software required a significant upfront capital outlay, along with significant ongoing operational costs to maintain the operability of these on-premises electronic devices. These operational costs may include the costs for deploying, managing, maintaining, upgrading, repairing and replacing these electronic devices.

Recently, more businesses and individuals have begun to rely on public cloud networks (hereinafter, “public cloud”) for providing users to a variety of services, from word processing application functionality to network management A “public cloud” is a fully virtualized environment with a multi-tenant architecture that provides tenants (i.e., users) with an ability to share computing and storage resources while, at the same time, retaining data isolation within each user's cloud account. The virtualized environment includes on-demand, cloud computing platforms that are provided by a collection of physical data centers, where each data center includes numerous servers hosted by the cloud provider. Examples of different types of public cloud networks may include, but is not limited or restricted to AMAZON WEB SERVICES®, MICROSOFT® AZURE®, GOOGLE CLOUD PLATFORM™ or ORACLE CLOUD™ for example.

This growing reliance on public cloud networks is due, in large part, to a number of cost saving advantages offered by this particular deployment. However, for many type of services, such as network management for example, network administrators face a number of challenges when business operations rely on operability of a single public cloud or operability of multiple public cloud networks. For instance, where the network deployed by an enterprise relies on multiple public cloud networks (hereinafter, “multi-cloud network”), network administrators have been unable to effectively attribute costs associated with various aspects of systems operating in a multi-cloud network. One reason for this is the difficulty in analyzing costs relative to actual usage of shared services that are utilized by multiple cost centers. Conventionally, these costs are divided evenly among cost centers, but such a division is inaccurate and can lead to a lack of optimization of allocated processing power and/or network usage. Likewise, there are no conventional solutions to visually monitor the costs associated with various aspects of systems incorporating multiple public cloud networks (multi-cloud network).

### SUMMARY

The systems and methods of the instant disclosure provide detailed analysis of distributed cloud computing systems to provide visibility and clarity into exactly how many shared services are being consumed and by which cost centers based on network usage. This allows users and cloud architects to easily analyze usage trends to identify and reallocate underutilized resources, identify areas for cost-optimization, and plan for cloud expenditures. By identifying under-utilized cloud network resources based on historical, current, and projected utilization, the invention offers insights for compute-resizing to optimize costs. The systems and methods track actual network traffic usage from cost centers (sources) to the shared cloud resource (destination) to create an accurate breakdown of accounts or subscriptions using the shared resources in the public cloud. Delivered through a simple and easily navigable interface, this visibility into who uses shared cloud resources helps enterprises improve accounting, budgeting, and cloud economics.

Among the benefits of the methods and systems disclosed herein are the ability to create shared services cost allocations, ability to create real-time and historic visualizations of cost allocations, and having cost telemetry built into the network. Shared services cost allocations provide accurate cost allocation based on actual network usage to shared cloud resources, provide insights for precise forecasting, budgeting, and reporting, and financial operations teams can leverage for chargeback/showback to easily distribute cost appropriately. Real-time and historical visibility of network usage across cost centers provides insight into all cloud account, subscription, and project usage details, provides always up to date allocation data with export capabilities to CFM applications, and provides an easy to use visual user interface outlining exactly which cost centers/resources are using. Having cost telemetry built into the network allows for detailed cost analysis that is based on user-defined cost centers and shared resources. Cost centers are easily defined by grouping cloud accounts/subscriptions, and shared resource groups may be created based on IP address or IP address groups.

In some aspects, a computerized method includes: receiving, from a controller, metadata pertaining to a plurality of constructs, wherein the controller is configured to (i) deploy and manage a first gateway in a first cloud computing network and a second gateway in a second cloud computing network and (ii) manage the plurality of constructs, wherein a first subset of the plurality of constructs are deployed in the first cloud computing network and a second subset of the plurality of constructs are deployed in a second cloud computing network, and wherein the first cloud computing network is provided by a first cloud computing environment resource provider and the second cloud computing network is provided by a second cloud computing environment resource provider different than the first cloud computing environment resource provider; receiving, from each of the first gateway and the second gateway, network data, wherein a combination of the metadata and the network data identify each of the plurality of constructs and in which cloud computing network each construct is deployed; generating a visualization illustrating a cost analysis of at least one construct of the plurality of constructs, and causing rendering of the visualization on a display screen of a network device.

In some aspects, generating the visualization comprises generating a dashboard comprising a plurality of frames, each frame of the plurality of frames displaying cost analysis data. In some aspects, a frame of the plurality of frames comprises an identification of one or more resources that could provide cost savings. In some aspects, the identification is based upon a comparison of network usage by the one or more resources with an allocated amount of network usage. In some aspects a frame of the plurality of frames comprises an identification of one or more resources that can be reconfigured to obtain a cost savings. In some aspects, a frame of the plurality of frames comprises an identification of costs by region for the first cloud computing environment resource provider and the second cloud computing environment resource provider. In some aspects, a frame of the plurality of frames comprises an identification of one or more cost centers, the one or more cost centers being arranged by cost. In some aspects, a frame of the plurality of frames comprises an identification of one or more shared services, the one or more shared services being arranged by cost. In some aspects, a frame of the plurality of frames comprises an identification of one or more least utilized resources. In some aspects, the one or more least utilized resources are identified based upon one or more of average CPU usage, average memory usage, and average packets per second.

In some aspects, the cost analysis comprises a plurality of boxes that detail costs associated with at least the first the first cloud computing environment resource provider and the second cloud computing environment resource provider, each box of the plurality of boxes being sized to scale based upon a magnitude of a cost represented by the box.

In some aspects, a non-transitory computer-readable medium having stored thereon logic that, when executed by one or more processors, causes operations including: receiving, from a controller, metadata pertaining to a plurality of constructs, wherein the controller is configured to (i) deploy and manage a first gateway in a first cloud computing network and a second gateway in a second cloud computing network and (ii) manage the plurality of constructs, wherein a first subset of the plurality of constructs are deployed in the first cloud computing network and a second subset of the plurality of constructs are deployed in a second cloud computing network, and wherein the first cloud computing network is provided by a first cloud computing environment resource provider and the second cloud computing network is provided by a second cloud computing environment resource provider different than the first cloud computing environment resource provider; receiving, from each of the first gateway and the second gateway, network data, wherein a combination of the metadata and the network data identify each of the plurality of constructs and in which cloud computing network each construct is deployed; generating a visualization illustrating a cost analysis of at least one construct of the plurality of constructs, and causing rendering of the visualization on a display screen of a network device.

In some aspects, a distributed cloud computing system comprising: a controller configured to deploy a first gateway in a first cloud computing network and a second gateway in a second cloud computing network, wherein the first cloud computing network is provided by a first cloud computing environment resource provider and the second cloud computing network is provided by a second cloud computing environment resource provider different than the first cloud computing environment resource provider; and logic, stored on non-transitory, computer-medium. Upon execution by one or more processors, the logic causes performance of operations including: receiving, from a controller, metadata pertaining to a plurality of constructs; receiving, from each of the first gateway and the second gateway, network data, wherein a combination of the metadata and the network data identify each of the plurality of constructs and in which cloud computing network each construct is deployed; generating a visualization illustrating a cost analysis of at least one construct of the plurality of constructs, and causing rendering of the visualization on a display screen of a network device.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is a diagram of an exemplary embodiment of a distributed cloud computing system including a controller managing constructs spanning multiple cloud networks, according to aspects of the disclosure;

FIG. 2A is an exemplary illustration of a logical representation of a controller deployed within a cloud computing platform, according to aspects of the disclosure

FIG. 2B, an exemplary illustration of a logical representation of the topology system logic deployed within a cloud computing platform, according to aspects of the disclosure;

FIGS. 3A and 3B illustrate an interface screen displaying portions of a dashboard of a visualization platform, according to aspects of the disclosure;

FIGS. 4A and 4B illustrates an interface screen displaying portions of a dashboard of a visualization platform, according to aspects of the disclosure;

FIGS. 5A and 5B illustrate an interface screen displaying portions of a dashboard of a visualization platform, according to aspects of the disclosure;

FIGS. 6A and 6B illustrate an interface screen displaying portions of a dashboard of a visualization platform, according to aspects of the disclosure; and

FIG. 7 illustrates an interface screen displaying portions of a dashboard of a visualization platform, according to aspects of the disclosure.

### DETAILED DESCRIPTION

Embodiments of the disclosure are directed to a system configured to provide operational visibility of a network that spans one or more cloud computing environments. According to one embodiment, the system may include a software instance that is operating in one or more cloud computing resources and is configured to collect information and render a graphic user interface (GUI) that provides an interactive, visual rendering of the connectively between constructs of a network spanning multiple (two or more) cloud computing environments (hereinafter, a “multi-cloud computing environment or a “multi-cloud network”). In other embodiments, the system includes the software instance and a controller configured to manage constructs deployed in one or more cloud computing environments such as within a multi-cloud environment and communicate with the software instance.

As will be discussed below in further detail, the software instance may query the controller for information using one or more Application Programming Interface (API) calls to retrieve information stored by the controller detailing status information of each construct managed by the controller. The controller obtains such information from one or more gateways deployed within a multi-cloud network, where the gateway(s) are configured to transmit this information to the controller on a periodic (or aperiodic) basis. It should be understood that, as discussed herein, the term “multi-cloud networks” refers a plurality of cloud networks, where each cloud network may constitute a public cloud network provided by a different cloud computing environment resource provider (hereinafter, “cloud provider”).

As is known in the art, a controller may be configured to program each gateway to control routing of network traffic such as by providing instructions to gateways as to how network traffic is routed among various gateways. As illustrative examples, the controller may instruct a gateway as to whether a virtual machine (VM) from one subnet work (hereinafter, “subnet”) may communicate directly with a VM from another subnet, or how network traffic will flow from a source to a destination within the cloud computing environment managed by the controller. In addition, embodiments of the disclosure discuss instructions provided by the software instance to the controller, which are then transmitted to one or more gateways by the controller and include instructions to transmit network data from the gateway to a routable address (e.g., an Internet Protocol “IP” address, etc.) of the software instance.

Therefore, as a general embodiment, the software instance may query the controller for data indicating a status and metadata of each construct managed by the controller and also receive network data from one or more gateways. The software instance includes logic that, upon execution by one or more processors (e.g., being part of the cloud computing resources), generates various visualizations that are a combination of the construct status, metadata (collectively “construct metadata”), the network data, and/or cost data that is based upon network usage and/or processing/memory usage. The visualizations may be interactive and provided to users such as network administrators, information technology (IT) professionals, or the like. Additionally, the visualizations may be configured to receive user input, which causes the logic of the software instance (“topology system logic”) to alter the visualizations. As discussed below and illustrated in the accompanying drawings, the visualizations may include, but are not limited or restricted to, a dashboard view providing overall status and health of the network as well as specific network parameters or cost analysis information; a dynamic topology mapping that provides a visual rendering of each construct and links that identify communications between the constructs; and a network flow visualization providing various illustrations detailing how network traffic is flowing (or has flowed) through the cloud computing environment managed by the controller. Each of the visualizations may provide data spanning a multi-cloud network.

By querying the controller for construct metadata and receiving network data from one or more gateways, the topology system logic may generate the exemplary visualizations described above, and those shown in the accompanying drawings, that illustrate a cost breakdown analysis. As is noted throughout, the illustrated cost breakdown analyses may correspond to constructs deployed in multiple cloud networks. Such operability provides numerous advantages to users over the current art by enabling users to view costs associated with the entire system that may span different public cloud networks. An additional functionality of the topology system logic is the generation of visualizations that illustrate costs associated with the network managed by the controller.

### I. Terminology

In the following description, certain terminology is used to describe features of the invention. In certain situations, the term “logic” is representative of hardware, firmware, and/or software that is configured to perform one or more functions. As hardware, the logic may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic may be software in the form of one or more software modules. The software module(s) may include an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “computerized” generally represents that any corresponding operations are conducted by hardware in combination with software and/or firmware.

The term “construct” may be construed as a virtual or physical logic directed to a particular functionality such as a gateway, virtual private cloud network (VPC), sub-network, or the like. For instance, as an illustrative example, the construct may correspond to virtual logic in the form of software (e.g., a virtual machine), which may assign a device-specific address (e.g., a Media Access Control “MAC” address) and/or an IP address within an IP address range supported by to a particular IP subnet. Alternatively, in some embodiments, the construct may correspond to physical logic, such as an electronic device that is communicatively coupled to the network and assigned the MAC and/or IP address(es). Examples of electronic devices may include, but are not limited or restricted to a personal computer (e.g., desktop, laptop, tablet or netbook), a mobile phone, a standalone appliance, a sensor, a server, or an information routing device (e.g., a router, bridge router (“brouter”), etc.). It is contemplated that each construct may constitute at least logic residing as part of a public network, although certain constructs may be deployed as part of an “on-premises” (or local) network.

The term “gateway” may refer to a software instance deployed within a public cloud network or a virtual private cloud network deployed with the public cloud network and controls the flow of data traffic within and from the public cloud network (e.g., to one or more remote sites including computing devices that may process, store and/or continue the routing of data). Herein, each gateway may operate as a “transit gateway” or “spoke gateway,” which are gateways having similar architectures but are identified differently based on their location/configurations within a cloud computing environment. For instance, a “spoke” gateway is configured to interact with targeted instances while a “hub” gateway is configured to further assist in the propagation of data traffic (e.g., one or more messages) directed to a spoke gateway or a computing device within an on-premises network.

The term “network traffic metrics” may refer to measurements of network traffic transmission including amount, frequency and/or latency. In some embodiments, network traffic metrics may include identification of a source and/or destination (e.g., IP address, originating/destination gateway, originating/destination VPC, originating/destination geographic region, etc.). Further, in some embodiments, network traffic metrics may also refer to analyses performed on and/or filtering of measurements of network traffic transmission.

The term “controller” may refer to a software instance deployed within a cloud computing environment (e.g., resources of a public cloud network) that manages operability of certain aspects of one or more cloud computing environments spanning across different public cloud networks (multi-cloud network). For instance, a controller may be configured to collect information pertaining to each VPC and/or each gateway instance and configures one or more routing tables associated with one or more VPCs and/or gateway instances spanning a multi-cloud network to establish communication links (e.g., logical connections) between different sources and destinations. These sources and/or destinations may include, but are not restricted or limited to on-premises computing devices, gateway instances or other types of cloud resources.

The term “message” generally refers to information in a prescribed format and transmitted in accordance with a suitable delivery protocol. Hence, each message may be in the form of one or more packets, frames, or any other series of bits having the prescribed format.

The term “link” may be generally construed as a physical or logical communication path between two or more constructs. For instance, as a physical communication path, wired and/or wireless interconnects in the form of electrical wiring, optical fiber, cable, bus trace, or a wireless channel using infrared, radio frequency (RF), may be used. A logical communication path includes any communication scheme that enables information to be exchanged between multiple constructs

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described

### II. General Architecture-Topology System

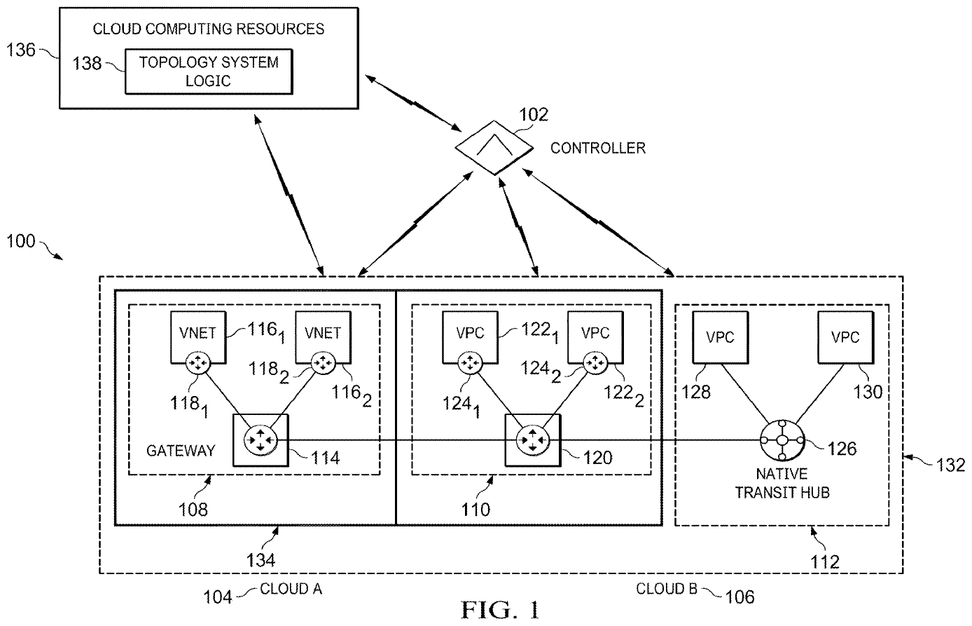

Referring to FIG. 1, a diagram of an exemplary embodiment of a distributed cloud management system 100 is shown, where the cloud computing system features a controller 102 for managing constructs residing in multiple cloud networks and a software instance 138 to visualize the managed constructs (hereinafter, “topology system logic”). More specifically, the controller 102 is configured to manage multiple constructs spanning multiple cloud networks, such as cloud (network) A 104 and cloud (network) B 106. In the exemplary illustration, cloud A 104 provides computing resources (“resources”) for a transit gateway 114 in communication with gateways 118₁-118₂ associated with virtual networks (VNETs) 116₁-116₂. Cloud B 106 provides resources for a transit gateway 120 in communication with gateways 124₁-124₂ associated with virtual private clouds (VPCs) 122₁-122₂. Cloud B 106 further provides resources for a native transit hub 126 in communication with VPCs 128 and 130. According to this embodiment of the disclosure, as shown in FIG. 1, the transit gateways 114, 120 and the native transit hub 126 are in communication with each other. Thus, as should be clearly understood that the controller 102 is managing several constructs, such as the illustrated gateways, that span multiple cloud networks.

Specifically, a first grouping of constructs 108 is deployed within the Cloud A 104, and second and third groupings of constructs 110, 112 are deployed within Cloud B 106. The controller 102 utilizes a set of APIs to provide instructions to and receive data (status information) associated with each of these constructs as well as status information pertaining to each connection between these constructs (link state). The construct metadata returned by a construct may depend on the type of construct (e.g., regions, VPCs, gateway, subnets, instances within the VPCs, etc.), where examples of construct metadata may include, but is not limited or restricted to one or more of the following construct parameters (properties): construct name, construct identifier, encryption enabled, properties of the VPC associated with that construct (e.g. VPC name, identifier and/or region, etc.), cloud properties in which the construct is deployed (e.g., cloud vendor in which the construct resides, cloud type, etc.), or the like.

Additionally, the cloud management system 100 includes topology system logic 138 processing on cloud computing resources 136. In some embodiments, the topology system logic 138 may be logic hosted on a user's Infrastructure as a Service (IaaS) cloud or multi-cloud environment. As one example, the topology system logic 138 may be launched as an instance within the public cloud networks (e.g., as an EC2® instance in AWS®). As an alternative example, the topology system logic 138 may be launched as a virtual machine in AZURE®. When launched, the topology system logic 138 is assigned a routable address such as a static IP address for example.

As shown, the topology system logic 138 is in communication with the controller 102 via, for example, an API that enables the topology system logic 138 to transmit queries to the controller 102 via one or more API calls. The topology system logic 138, upon execution by the cloud computing resources 136, performs operations including querying the controller 102 via API calls for construct metadata in response to a particular event. The particular event may be in accordance with a periodic interval or an aperiodic interval or a triggering events such as a user request for a visualization via user input.

In some embodiments, in response to receiving a query via an API call from the topology system logic 138, the controller 102 accesses data stored on or by the controller 102 and returns the requested data via the API to the topology system logic 138. For example, the topology system logic 138 may initiate one or more queries to the controller 102 to obtain topology information associated with the constructs managed by the controller 102 (e.g., a list of all gateways managed by the controller 102, a list of all VPCs or VNETs managed by the controller 102, or other data gathered from database tables) along with status information associated with each construct as described above.

Upon receiving the requested construct metadata, the topology system logic 138 performs one or more analyses and determines whether any additional construct metadata needs to be requested. For example, the topology system logic 138 may provide a first query to the controller 102 requesting a list of all gateways managed by the controller 102. In response to receiving the requested construct metadata, the topology system logic 102 determines the interconnections between the gateways listed. Subsequently, the topology system logic 138 may provide a second query to the controller 102 requesting a list of all VPCs managed by the controller. In response to receiving the requested construct metadata, the topology system logic 138 determines the associations between each VPC and a corresponding gateway.

For example, in some embodiments, the received construct metadata provides detailed information for each gateway enabling the topology system logic 138 to generate a data object, e.g., a database table of the construct metadata, that represents a gateway. The data object representing the multiple gateways are cross-referenced to build out a topology mapping based on the parameters of each gateway, which may include, inter alia: cloud network user account name; cloud provider name; VPC name; gateway name; VPC region; sandbox IP address; gateway subnet identifier; gateway subnet CIDR; gateway zone; name of associated cloud computing account; VPC identifier; VPC state; parent VPC name; VPC CIDR; etc. Similarly, the construct metadata is also utilized to generate a data object representing each VPC object and each subnet object.

Additionally, in order to determine whether a connection within the network is between two transit gateways, a separate API call may be utilized by the topology system logic 138 to query the controller 102 for a listing of all transit gateways. Thus, the topology system logic 138 is then able to determine whether a connection between a first gateway and a second gateway is between two transit gateways. In some embodiments, as will be discussed below, the connections between transit gateways and the connections between a spoke gateway and a transit may be represented visually in two distinct methods.

In addition to receiving the construct metadata from the controller 102, the topology system logic 138 may also receive network data from one or more gateways managed by the controller 102. The topology system logic 138 may also initiate one or more queries to the controller 102 to track network usage by the constructs of cloud management system 100. Network usage may be tracked for each construct/resource of cloud management system 100 and stored in database (e.g., network database 222). The tracked network usage may be used to provide real-time and/or historic cost information. The cost information may be grouped by defined cost centers, by CSP, and the like. Cost centers may be user created groupings of constructs/resources that are related (e.g., marketing, sales, support, engineering, mail server, etc.). Network data may include for each network packet, but is not limited or restricted to, an ingress interface, a source IP address, a destination IP address, an IP protocol, a source port for UDP or TCP, a destination port for UDP or TCP, a type and code for ICMP, an IP “Type of Service,” etc. In one embodiment, the network data may be transmitted to the topology system logic 138 from a gateway using an IP protocol, for example, UDP. In some embodiments, the network data is collected and exported via the NetFlow network protocol.

In order to configure a gateway to transmit the network data to the topology system logic 138, the topology system logic 138 may provide instructions to the controller 102, which in turn provides the instructions to each gateway managed by the controller 102. The instructions provide the IP address of the topology system logic 138, which is used as the IP address for addressing the transmission of the network data.

As will be discussed in detail below, the topology system logic 138 may generate a visualization platform comprising one or more interactive display screens. These display screens may include a dashboard, a topology mapping and a network flow visualization. Additionally, the visualization platform may be configured to receive user input that causes filtering of the of the displayed data.

For example and still with reference to FIG. 1, the topology system logic 138 may generate a topology mapping visualization of the connections linking the constructs detected by the controller 102, which are illustrated by the constructs within a logical region 132 represented by Cloud A 104 and Cloud B 106. Additionally, the topology system logic 138 may generate various graphical user interfaces (GUIs) that illustrates network traffic flows, traffic flow heat maps, packet capture, network health, link latency, encryption, firewalls, etc., of network traffic flowing between, to and from constructs managed by the controller 102 as illustrated by a second logical region 134.

Further still, the topology system logic 138 may generate a visualization of costs associated with various aspects of distributed cloud management system 100. Costs may be determined, monitored, and/or displayed, and include: costs by domain, costs by cloud provider, costs by regions, costs by type (e.g., marketing, sales, support, and the like), costs by centers (e.g., line of business or application that has a billing center), costs by shared service (e.g., applications, services, or traffic destinations that multiple cost centers use) and the like. Costs may be broken down into successively granular components as desired to more specifically assess monetary spend regarding cloud management system 100. Costs may be based upon network traffic, fixed costs associated with cloud services, and the like.

Embodiments of the disclosure offer numerous advantages over current systems that provide a dashboard illustrating costs as current systems do not provide the ability to visualize costs associated with all aspects of a system deployed across multiple cloud networks. As one example, an enterprise network may utilize resources deployed in a plurality of cloud networks and an administrator of the enterprise network may desire to obtain visualization of costs associated with these resources. However, because the enterprise network spans multiple cloud networks, conventional systems fail to provide such a solution.

As used herein, a visualization (or visual display) of the costs associated with constructs and connections therebetween is referred to as a cost-based topology mapping. Current systems fail to provide a cost-based topology mapping across multiple cloud networks and fail to allow an administrator to search across multiple cloud networks or visualize how changes in a state of a construct or connection affects the costs of operating cloud management system 100. In some embodiments, the cost-based topology mapping dynamically changes as configuration and/or usage of a construct or connection changes based upon user selections.

In some embodiments, a network may be deployed across multiple cloud networks using a plurality of controllers to manage operability of the network. In some such embodiments, each controller may gather the information from the network and constructs which it manages and a single controller may obtain all such information, thereby enabling the visualization platform to provide visibility across a network (or networks) spanning multiple controllers.

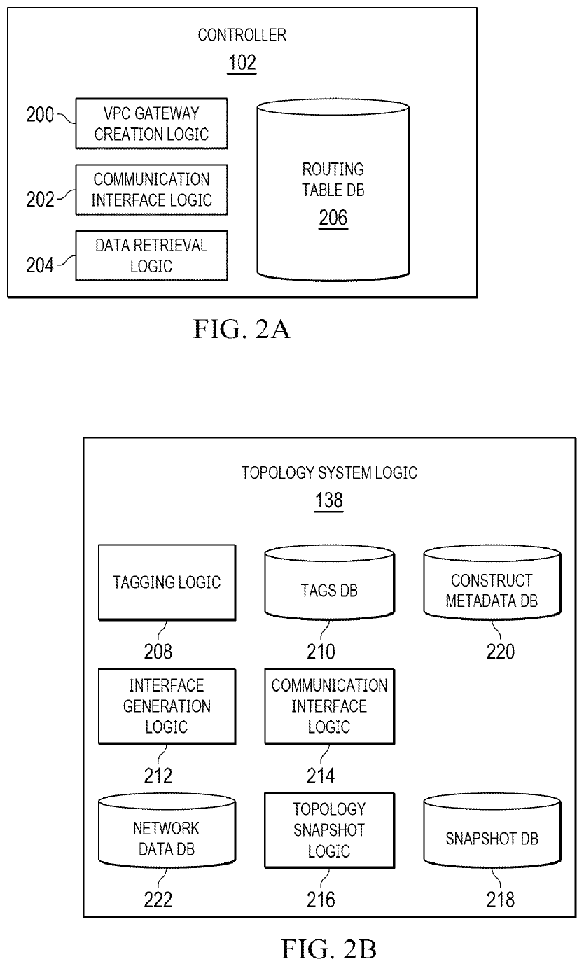

Referring to FIG. 2A, an exemplary illustration of a logical representation of the controller 102 deployed within the cloud management system 100 is shown in accordance with some embodiments. The controller 102, as noted above, may be a software instance deployed within the cloud network to assist in managing operability of constructs within multiple public cloud networks. According to this embodiment, the controller 102 may be configured with certain logic modules, including, a VPC gateway creation logic 200, a communication interface logic 202 and a data retrieval logic 204. The controller 102 may also include a routing table database 206.

In some embodiments, the gateway creation logic 200 performs operations to create a gateway within a VPC including creating a virtual machine within a VPC, provide configuration data to the virtual machine, and prompt initialization of the gateway based on the configuration data. In one embodiment in which the cloud computing resources utilized are AWS®, the VPC gateway creation logic 200 launches a virtual machine within a VPC, the virtual machine being an AMAZON® EC2 instance. The virtual machine is launched using a pre-configured virtual machine image published by the controller 102. In the particular embodiment, the virtual machine image is an Amazon Machine Image (AMI). When launched, the virtual machine is capable of receiving and interpreting instructions from the controller 102.

The communication interface logic 202 may be configured to communicate with the topology system logic 138 via an API. The controller 102 may receive queries from the topology system logic 138 via one or more API calls and respond with requested data via the API.

The data retrieval logic 204 may be configured to access each construct managed by the controller 102 and obtain construct metadata therefrom. Alternatively, or in addition, the data retrieval logic 204 may receive such construct metadata that is transmitted (or “pushed”) from the constructs without the controller 102 initiating one or more queries (e.g., API calls).

The routing table database 206 may store VPC routing table data. For example, the controller 102 may configure a VPC routing table associated with each VPC to establish communication links (e.g., logical connections) between a transit gateway and cloud instances associated with a particular instance subnet. A VPC routing table is programmed to support communication links between different sources and destinations, such as an on-premise computing devices, a cloud instance within a particular instance subnet or the like. Thus, the controller 102 obtains and stores information that reveals certain properties of resources (e.g., constructs such as gateways, subnets, VPCs, instances within VPCs, etc.) within the purview of the controller 102 as well as status information pertaining to the connections (communication links) between with these resources.

Referring to FIG. 2B, an exemplary illustration of a logical representation of the topology system logic 138 deployed within a cloud computing platform is shown in accordance with some embodiments. The topology system logic 138 may be a software instance deployed using the cloud computing resources 136 and is configured to communicate with the controller 102 and each of the gateways managed by the controller 102. The topology system logic 138 is configured with certain logic modules, including, a tagging logic 208, a tags database 210, an interface generation logic 212, a communication interface logic 214, a topology snapshot logic 216. Additionally, the topology system logic 138 may include a snapshot database 218, a construct metadata database 220 and a network data database 222.

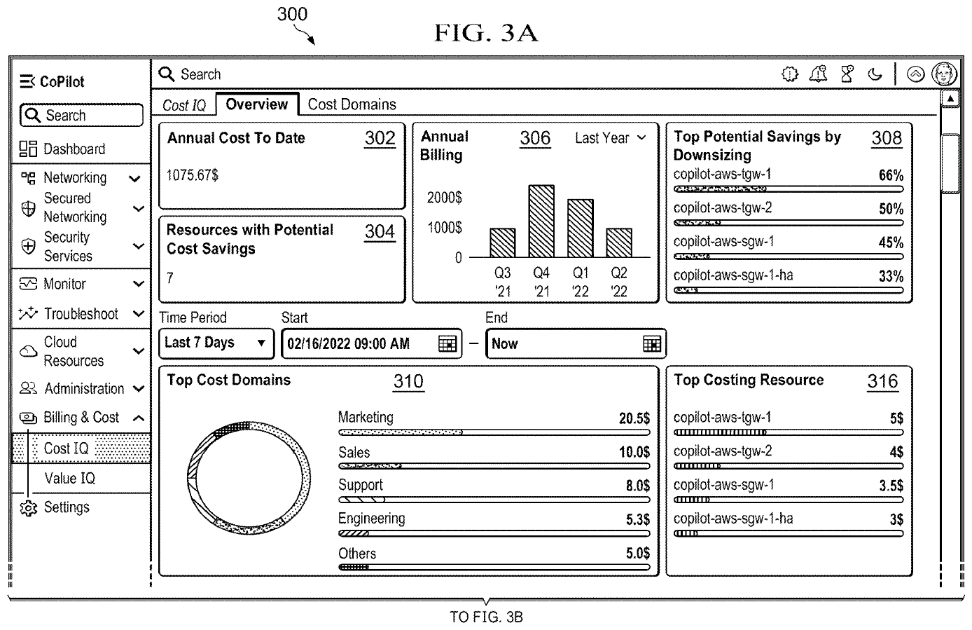

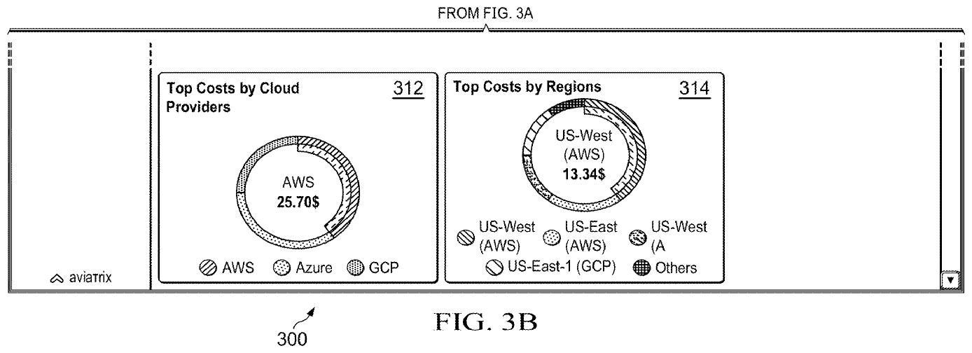

In some embodiments, the tagging logic 208, upon execution by one or more processors, performs operations as discussed below with respect to FIGS. 3-7. In some embodiments, the tags generated by the tagging logic 208 may be stored in the tags database 210.

In some embodiments, the interface generation logic 212, upon execution by one or more processors, performs operations as discussed below and that cause generation of exemplary interactive user interfaces as illustrated in FIGS. 3-7.

In some embodiments, the communication interface logic 214, upon execution by one or more processors, performs operations as discussed herein pertaining to querying a controller for cost analysis and receiving the requested cost analysis metadata. In some embodiments, the received cost analysis metadata may be stored in the metadata database 220.

### III. Exemplary User Interfaces-Cost Breakdown Visualization Platform

Referring to FIGS. 3A and 3B, a dashboard 300 illustrating a cost breakdown for a distributed cloud management system is shown, according to aspects of the disclosure. Dashboard 300 provides an overview of a plurality of cost breakdown visualizations to inform a user of the costs associated with various aspects of a distributed cloud management system (e.g., distributed cloud management system 100). Dashboard 300 enables a user to create cost domains, aggregate account data from multiple CSPs (AWS, Azure, GCP, etc.), aggregate network domains, and aggregate gateways (spokes and edges). Cost information displayed via dashboard 300 may be filtered by date using dropdowns.

As shown in FIGS. 3A and 3B, dashboard 300 provides an overview of a plurality of cost parameters. For example, frame 302 displays annual cost to date, frame 304 identifies the number of resources that may be modified for a potential cost savings, frame 306 reports annual billing information (e.g., quarter by quarter breakdowns of prior years for comparison), frame 308 displays top potential savings by downsizing, frame 310 displays top cost domains, frame 312 displays top costs by cloud provider, frame 314 displays top costs by region, and frame 316 displays top costing resources.

Frame 302 displays the annual cost to date for costs associated with cloud management system 100. In various aspects, costs are derived from data associated with cloud management system 100 that is monitored and recorded by controller 102. For example, as initiated by topology system logic 138, controller 102 monitors network traffic data of cloud management system 100. This data is stored (e.g., in databases 220, 222) and used for various purposes, including cost analyses. The value reported in frame 302 is a cost that is determined based upon network traffic and/or instance costs associated with one or more CSPs. Additional frames displayed in dashboard 300 provide additional details regarding the annual cost to date illustrated in frame 302.

Frame 304 displays the number of resources with potential costs savings. Resources with potential cost savings are identified by controller 102. For example, costs associated with resources may be determined by the amount of network data associated with a particular resource. Controller 102 monitors and analyzes network data usage. Controller 102, after analyzing the network data usage, flags a resource as a potential cost saving if the monitored resource is underutilizing the amount of data transfer that has been paid for. In such situations, a cost savings can be created by reducing the amount of network data allocated to the resource. Potential cost savings increase with each new resource that is identified by controller 102. Frame 304 provides a high-level summary of targets that can result in cost savings with regard to cloud management system 100.

In other aspects, costs may be attributed to an instance type or size. For example, the amount of processing power allocated to a resource or task may be the driving factor for cost. Controller 102 monitors and analyzes the processing power associated with an instance and flags those instances that are underutilizing their allocated processing power. In such situations, a cost savings can be created by reducing the amount of processing power that is allocated to an instance or resource.

Frame 306 displays a graph of annual billing for the previous year, broken down by quarter. This information provides further insight into the expected and/or historical billing associated with cloud management system 100. As shown in FIGS. 3A and 3B, an expected billing trend shows that costs associated with cloud management system 100 are historically higher in Q4 and Q1. This information provides a user with insight regarding expectations of cost increases and decreases, which can help inform decisions regarding scaling up or down data and/or processing allocated to a resource/instance.

Frame 308 displays top potential savings by downsizing. Frame 308 provides additional detail regarding the resources quantified in frame 304. By way of example, FIG. 3A illustrates four resources that can be downsized to obtain a cost savings. Each of the four resources also includes a percent score that indicates, for example, how much of a reduction could be made to the resource.

Frame 310 displays a list of domains and organizes them by cost to provide a user with information regarding which domains have the greatest costs. Frame 310, as shown in FIG. 3A, provides both a ring graph that visually indicates cost spend per domain and a bar chart that provides the same information. In some aspects, frame 310 includes only one of the two graphs. Frame 310 allows a user to quickly and efficiently see a cost breakdown per domain. Using frame 310, a user may be informed as to potential cost savings by altering how a domain is operating.

Frame 312 displays a ring graph displaying top costs by cloud provider to provide a user with information regarding which cloud providers have the greatest costs. Frame 312 is useful to show how cloud management system 100 is utilizing resources at the CSP level. Using frame 312, a user may be informed as to potential cost savings by altering usage of one or more CSPs.

Frame 314 displays top costs by region to provide a user with information regarding which region has the greatest costs. Frame 314 is useful to show how cloud management system 100 is utilizing resources at the region level. Using frame 314, a user may be informed as to potential cost savings by altering traffic through one or more CSP regions.

Frame 316 displays top costing resources to help identify resources that could have potential cost savings. For example, it may be possible to limit or reroute traffic associated with an identified resource to reduce an amount of network data the resource utilizes (and then ultimately reduce the amount of network data allocated to that resource).

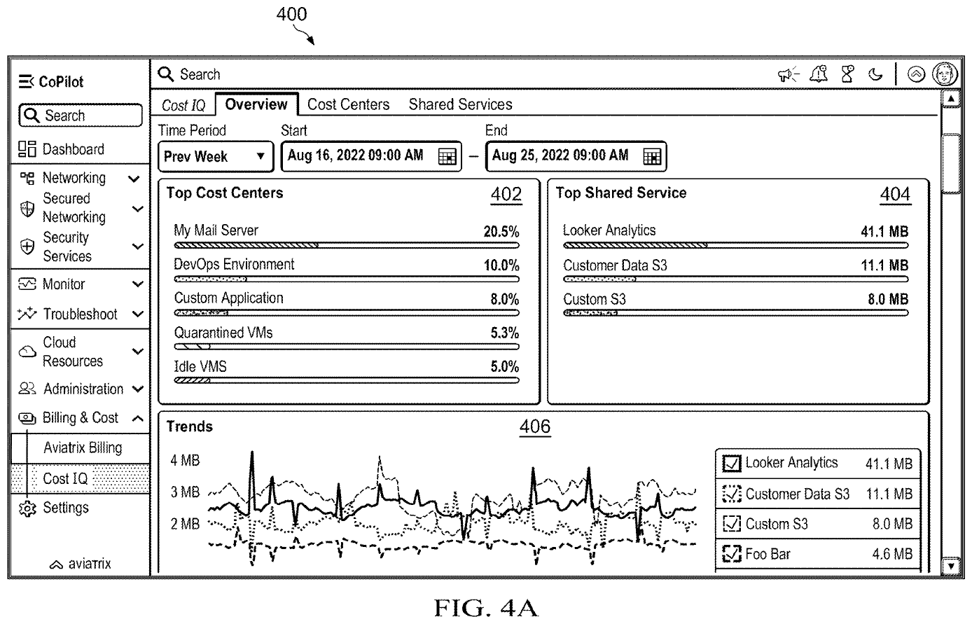

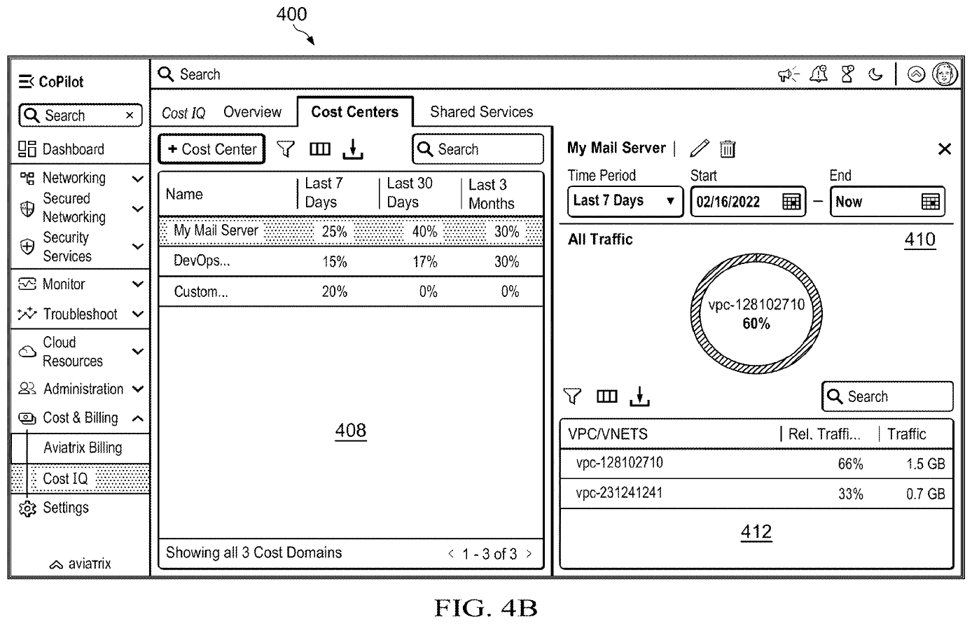

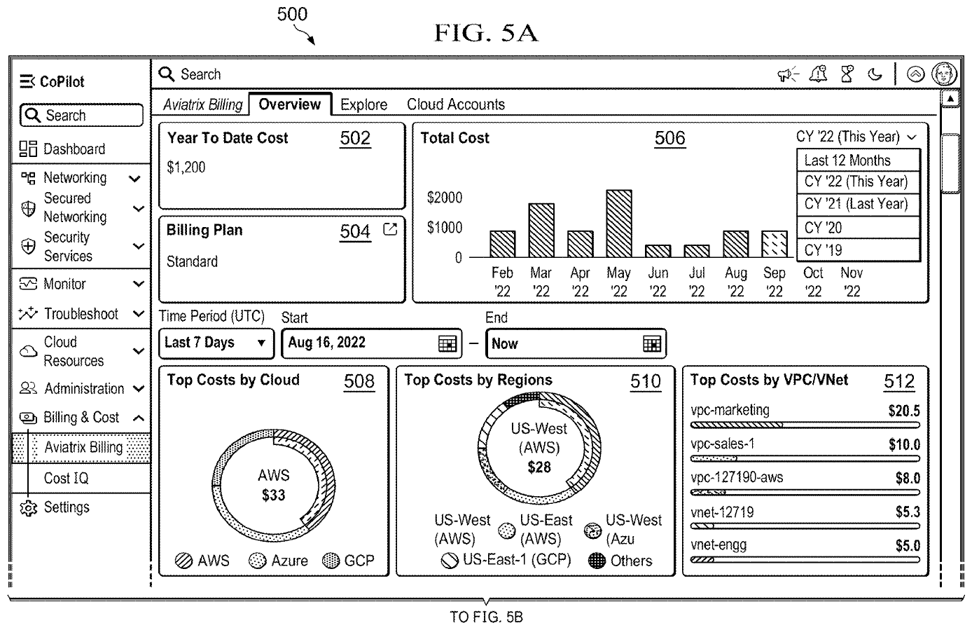

Referring to FIGS. 4A and 4B, a dashboard 400 illustrating cost breakdowns for a distributed cloud management system is shown, according to aspects of the disclosure. FIG. 4B illustrates more detailed cost information relative to FIG. 4A. FIG. 4A includes a frame 402 that illustrates top cost centers, a frame 404 that illustrates top shared services, and a frame 406 that illustrates data usage trends by resource.

Frame 402 identifies the top cost centers associated with cloud management system 100. Cost centers may be user-defined and represent a line of business or an application that has a billing center. Frame 402 provides a user with insight as to which cost centers have the highest costs, allowing a user to investigate these cost centers to make changes to reduce costs. Frame 404 identifies the top shared services associated with cloud management system 100. Shared services are those services that are used by multiple cost centers. Frame 404 provides a user with insight as to which shared services have the highest costs, allowing a user to investigate these cost centers to make changes to reduce costs. Frame 406 is a graph of data usage trends by resources over a specified period of time. Frame 406 provides insight into the amount of periodic data usage by various resources. Frame 406 can help visually identify resources that are using abnormally high or low amounts of data. The user can then make changes to these resources to reduce costs (e.g., allocate less data to those resources that do not need it to reduce costs).

Referring now to FIG. 4B, dashboard 400 has been manipulated by a user to provide more specific information regarding cost centers and includes a frame 408 that displays information about cost centers over different time periods, a frame 410 that displays network data usage by the mail server, and a frame 412 that displays a summary of all mail traffic for each mail server in cloud management system 100.

Frame 408 provides data regarding various cost centers during multiple time periods. For example, as shown in FIG. 4B, multiple cost centers are shown (e.g., mail server, DevOps, and Custom). For each cost center, data usage (in %) is shown for three time periods (last 7 days, last 30 days, and last 3 months). Frame 408 allows a user to gain insight into the network data usage of various cost centers. With this insight, the user can make adjustments to the cost centers to reduces costs associated therewith. Frames 410 and 412 provide more detailed information regarding the mail center cost center, providing percentage breakdowns within the cost center regarding resources of the cost center (e.g., a breakdown of how much data each VPC uses).

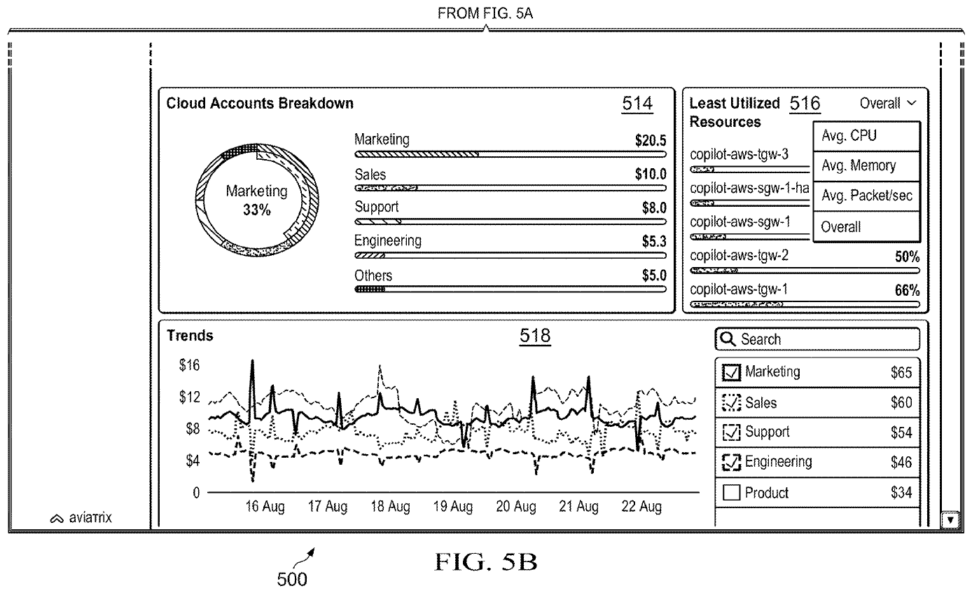

Referring to FIGS. 5A and 5B, a dashboard 500 illustrating cost breakdowns for a distributed cloud management system is shown, according to aspects of the disclosure dashboard 500 is similar to dashboard 300, but includes some different cost breakdown metrics. A frame 502, is similar to frame 302 and provides data regarding the cost accrued year to date. A frame 504 indicates the type of billing plan associated with cloud management system 100. A frame 506 provides data regarding costs for a plurality of years, further broken down by month. Frame 506 helps highlight changes in network data usage over time to highlight differences in data usage to identify areas that might provide reduces costs through optimization. A frame 508 is similar to frame 312 and provides data regarding individual CSPs. A frame 510 is similar to frame 314 and provides more specific data regarding CSP costs by regions. A frame 512 provides data regarding top costs by VPC/Vnet. Frame 512 provides insight into which VPCs/Vnets are using the most network data. Those resources that are consuming the most data are candidates for further investigation and optimization to reduce costs. A frame 514 provides data regarding cloud accounts, detailing costs on an account-by-account basis. A frame 516 provides data regarding the least utilized resources. This frame can be customized to use different parameters for the utilization, including average CPU usage, average memory usage, average packets/second, or an overall rating that combines each of the former parameters. Identifying the least utilized resources provides an indication of where changes can be made to reduce costs. For example, if a resource is greatly underutilizing an allocated CPU, then it may be possible to allocate less processing power to that resource to reduce costs. A frame 518 is similar to frame 406 and provides cost trends for various cost centers.

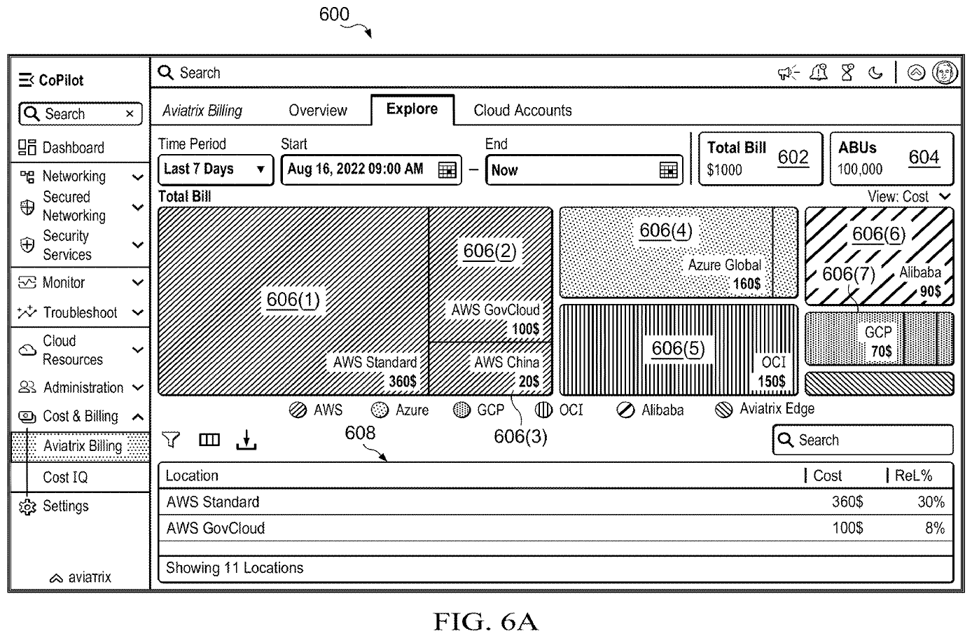

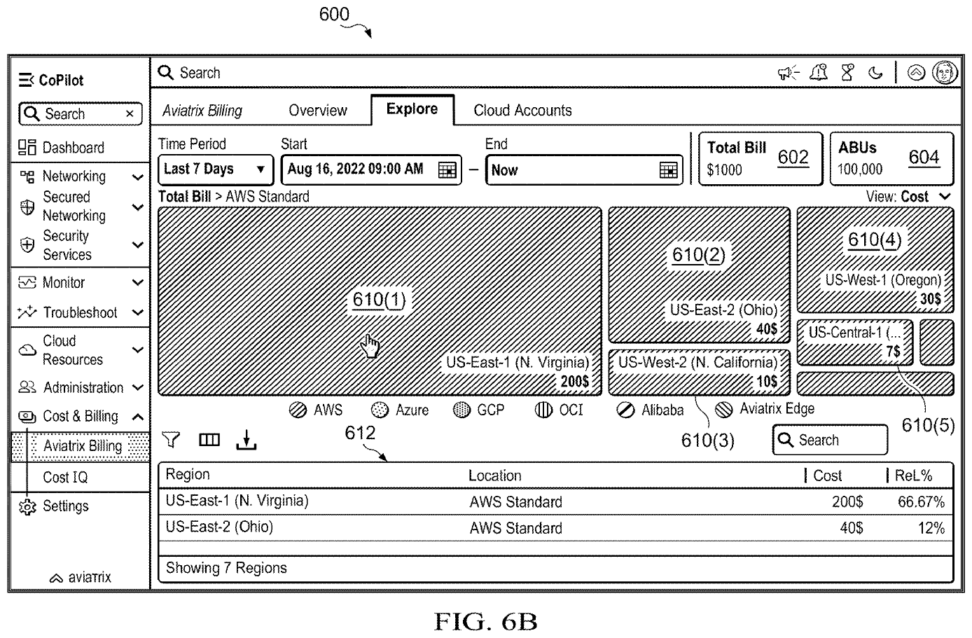

Referring now to FIGS. 6A and 6B, a dashboard 600 illustrating billing breakdowns for a distributed cloud management system is shown according to aspects of the disclosure. Dashboard 600 is useful for providing a detailed breakdown of costs associated cloud management system 100. For example, FIG. 6A illustrates a breakdown of a total bill that is displayed in a frame 602. A frame 604 displays a custom billing unit. Dashboard 600 includes drop downs that allow a user to filter the data by different date ranges. Visual data that displays the billing information is displayed in boxes 606(1)-(7). Each box 606 represents a component of the total bill. Each box 606 is scaled in size to visually represent the proportion of the total bill associated with each box. Boxes 606 may represent charges from CSPs and other expenses from various vendors. In addition to being scaled, each box 606 may be color coded to group certain expenses together. For example, a charge from a particular CSP may be broken down into related sub parts (e.g., region by region or for different types of services). A frame 608 displays some of the visual information from boxes 606 in chart form.

Referring now to FIG. 6B, dashboard 600 is shown that provides more detail regarding box 606(1) from FIG. 6A. Box 606(1) has been broken down into boxes 610(1)-(5). By way of example, box 606(1) may detail information regarding a particular CSP. Dashboard 600 gives the user the ability to select box 606(1) to obtain more information regarding the costs associated with that charge. Selecting box 606(1) causes dashboard 600 to display boxes 610(1)-(5) as illustrated in FIG. 6B. Boxes 610(1)-(5) display charges on a region basis for that CSP. As in FIG. 6A, each box 610 is scaled in size to visually depict the percentage of the bill with respect to box 606(1). A frame 612 displays some of the visual information from boxes 610 in chart form.

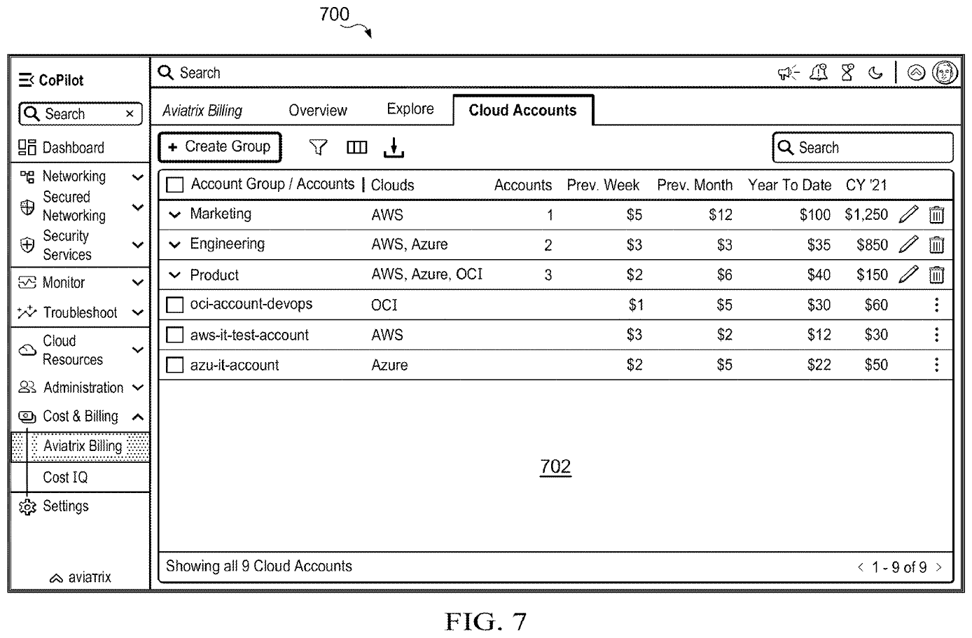

Referring now to FIG. 7, a dashboard 700 is shown that illustrates the ability of a user to create custom groups for billing analysis. Dashboard 700 includes a frame 702 that allows users to build custom groupings for their lines of business. Users can create logical groups that include accounts from any CSP that they use and are able to assign costs of operating their network for their lines of business or applications. For example, if there are two accounts for sales and four accounts for development, the accounts can be grouped for development and sales into their own groups so that when the customer splits up their network bill it is easy to allocate the cost for operating the network to the appropriate lines of business.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A computerized method comprising:
receiving, from a controller, metadata pertaining to a plurality of constructs, wherein the controller is configured to (i) deploy and manage a first gateway in a first cloud computing network and a second gateway in a second cloud computing network and (ii) manage the plurality of constructs, wherein a first subset of the plurality of constructs are deployed in the first cloud computing network and a second subset of the plurality of constructs are deployed in a second cloud computing network, and wherein the first cloud computing network is provided by a first cloud computing environment resource provider and the second cloud computing network is provided by a second cloud computing environment resource provider different than the first cloud computing environment resource provider;
receiving, from each of the first gateway and the second gateway, network data, wherein a combination of the metadata and the network data identify each of the plurality of constructs and in which cloud computing network each construct is deployed;
generating a visualization illustrating a cost analysis of at least one construct of the plurality of constructs, and
causing rendering of the visualization on a display screen of a network device.

2. The computerized method of claim 1, wherein generating the visualization comprises generating a dashboard comprising a plurality of frames, each frame of the plurality of frames displaying cost analysis data.

3. The computerized method of claim 2, wherein a frame of the plurality of frames comprises an identification of one or more resources that could provide cost savings.

4. The computerized method of claim 3, wherein the identification is based upon a comparison of network usage by the one or more resources with an allocated amount of network usage.

5. The computerized method of claim 2, wherein a frame of the plurality of frames comprises an identification of one or more resources that can be reconfigured to obtain a cost savings.

6. The computerized method of claim 2, wherein a frame of the plurality of frames comprises an identification of costs by region for the first cloud computing environment resource provider and the second cloud computing environment resource provider.

7. The computerized method of claim 2, wherein a frame of the plurality of frames comprises an identification of one or more cost centers, the one or more cost centers being arranged by cost.

8. The computerized method of claim 2, wherein a frame of the plurality of frames comprises an identification of one or more shared services, the one or more shared services being arranged by cost.

9. The computerized method of claim 2, wherein a frame of the plurality of frames comprises an identification of one or more least utilized resources.

10. The computerized method of claim 9, wherein the one or more least utilized resources are identified based upon one or more of average CPU usage, average memory usage, and average packets per second.

11. The computerized method of claim 1, wherein the cost analysis comprises the cost analysis comprises a plurality of boxes that detail costs associated with at least the first the first cloud computing environment resource provider and the second cloud computing environment resource provider, each box of the plurality of boxes being sized to scale based upon a magnitude of a cost represented by the box.

12. A non-transitory computer-readable medium having stored thereon logic that, when executed by one or more processors, causes operations including:
receiving, from a controller, metadata pertaining to a plurality of constructs, wherein the controller is configured to (i) deploy and manage a first gateway in a first cloud computing network and a second gateway in a second cloud computing network and (ii) manage the plurality of constructs, wherein a first subset of the plurality of constructs are deployed in the first cloud computing network and a second subset of the plurality of constructs are deployed in a second cloud computing network, and wherein the first cloud computing network is provided by a first cloud computing environment resource provider and the second cloud computing network is provided by a second cloud computing environment resource provider different than the first cloud computing environment resource provider;
receiving, from each of the first gateway and the second gateway, network data, wherein a combination of the metadata and the network data identify each of the plurality of constructs and in which cloud computing network each construct is deployed;
generating a visualization illustrating a cost analysis of at least one construct of the plurality of constructs, and causing rendering of the visualization on a display screen of a network device.

13. The non-transitory computer-readable medium of claim 12, wherein generating the visualization comprises generating a dashboard comprising a plurality of frames, each frame of the plurality of frames displaying cost analysis data.

14. The computerized method of claim 13, wherein a frame of the plurality of frames comprises an identification of one or more resources that could provide cost savings.

15. The computerized method of claim 14, wherein the identification is based upon a comparison of network usage by the one or more resources with an allocated amount of network usage.

16. The computerized method of claim 13, wherein a frame of the plurality of frames comprises an identification of one or more resources that can be reconfigured to obtain a cost savings.

17. The computerized method of claim 13, wherein a frame of the plurality of frames comprises an identification of costs by region for the first cloud computing environment resource provider and the second cloud computing environment resource provider.

18. The computerized method of claim 13, wherein a frame of the plurality of frames comprises an identification of one or more cost centers, the one or more cost centers being arranged by cost.

19. The computerized method of claim 13, wherein a frame of the plurality of frames comprises an identification of one or more shared services, the one or more shared services being arranged by cost.

20. The computerized method of claim 13, wherein a frame of the plurality of frames comprises an identification of one or more least utilized resources.

21. The computerized method of claim 20, wherein the one or more least utilized resources are identified based upon one or more of average CPU usage, average memory usage, and average packets per second.

22. The computerized method of claim 12, wherein the cost analysis comprises the cost analysis comprises a plurality of boxes that detail costs associated with at least the first the first cloud computing environment resource provider and the second cloud computing environment resource provider, each box of the plurality of boxes being sized to scale based upon a magnitude of a cost represented by the box.

23. A distributed cloud computing system comprising:
a controller configured to deploy a first gateway in a first cloud computing network and a second gateway in a second cloud computing network, wherein the first cloud computing network is provided by a first cloud computing environment resource provider and the second cloud computing network is provided by a second cloud computing environment resource provider different than the first cloud computing environment resource provider; and
logic, stored on non-transitory, computer-medium, that, upon execution by one or more processors, causes performance of operations including:
receiving, from a controller, metadata pertaining to a plurality of constructs;
receiving, from each of the first gateway and the second gateway, network data, wherein a combination of the metadata and the network data identify each of the plurality of constructs and in which cloud computing network each construct is deployed;
generating a visualization illustrating a cost analysis of at least one construct of the plurality of constructs, and
causing rendering of the visualization on a display screen of a network device.
